(19) United States
(12) Patent Application Publication
(10) Pub. No.: US 2010/0309746 A1
(43) Pub. Date: Dec. 9, 2010

(54) Ultraclean Magnetic Mixer with Shear-Facilitating Blade Openings

(76) Inventor: Per-Olof K. Andersson, Racine, WI (US)

Correspondence Address: JANSSON SHUPE & MUNGER LTD., 245 MAIN STREET, RACINE, WI, 53403, US

(21) Appl. No.: 12/478,926

(22) Filed: Jun. 5, 2009

(51) Int. Cl. B01F 15/02

(52) U.S. Cl. 366/165.3

(57) ABSTRACT

A magnetically-coupled liquid mixer having a drive mount secured to and extending into a mixing vessel, a vessel-external first magnet array adjacent to the drive mount, a stub shaft extending into the vessel and having a first thrust bearing surface, a driven portion rotating on the stub shaft and having radially-mounted mixing blades a subset of which is characterized by each having an opening through which liquid flows during rotation, a second thrust bearing surface, and a second magnet array, the arrays being positioned with respect to one another such that the thrust bearing surfaces are spaced apart at least in the absence of above-threshold fluid dynamic thrust forces on the driven portion, the blade-opening feature introducing increased fluid shear into the liquid.

### FIELD OF THE INVENTION

This invention relates to mixing technology as used for the mixing of food products, pharmaceuticals, chemical products and the like using magnetically-coupled transmission of power through the wall of a mixing vessel so that no seal is required in the vessel wall.

### BACKGROUND OF THE INVENTION

Many production processes require mixing of liquids in an ultraclean operation. Such production processes may include the mixing of products such as pharmaceuticals, foods and chemicals. Certain of these may require aseptic processing. The term ultraclean as used herein refers in general to particularly stringent requirements for the levels of contamination which are acceptable in such processes.

Contamination in mixing processes may come from a number of sources. Among these are the mixing equipment itself and the cleaning processes which are invariably required during the use of such equipment.

One source of contamination comes from seals which may be required to seal a piece of equipment; contamination may penetrate into the mixing vessel through such seals. Seals may be required, for example, around a rotary drive shaft to drive a mixer in the vessel. For this and other reasons, elimination of such seals is highly desirable. The mixer disclosed in U.S. Pat. No. 7,396,153 (Andersson) eliminates the seal through the use of magnetic coupling of the rotary power through the wall of a mixing vessel. Magnet arrays, one external to the vessel and adjacent to a drive mount secured to the vessel and one in a driven portion which includes the mixing blades, are positioned with respect to each other such that thrust bearing surfaces on the drive mount and the driven portion are spaced apart when the fluid dynamic thrust forces on the driven portion are below a certain threshold level. The magnetic coupling eliminates the seal in the vessel wall while the characteristic of being spaced apart contributes to the ultracleanliness of this type of mixer, since another source of contamination is the relative movement of bearing surfaces against one another. The Andersson '153 patent, commonly-owned by the owner of the present invention, is incorporated in its entirety herein by reference.

There is a need for more rapid and complete mixing of the components being mixed by such mixers. Numerous variables have an effect on the mixing process, including but not limited to the rotational speed of the driven portion, the size of the mixing blades, the shape of the mixing blades, and the location of the mixer in the mixing vessel. And, of course, the physical properties of the components being mixed also affect the mixing performance of such a mixer. Introducing shear into the mixing flow in the vessel is desirable and an important element in determining mixing performance, and the amount of shear introduced into the liquid can be greatly enhanced by the inclusion of openings in the mixing blades. The edges of the openings provide locations in the flow for turbulence and flow separation to occur, thereby introducing shear into the flow through and around such openings.

In certain components being mixed, it is not desirable for the mixing process to incorporate air into the mixed liquid, and therefore the rotational speeds must be kept low, while at the same time it is desirable for thorough mixing to be achieved rapidly. The inventive mixer can achieve such rapid and thorough mixing while avoiding the incorporation of air into the liquid.

### OBJECTS OF THE INVENTION

It is an object of this invention to provide a magnetically-coupled mixer for liquids which overcomes the problems and shortcomings of the prior art.

It is an object of this invention to provide a magnetically-coupled liquid mixer which is effective in introducing a large amount of fluid shear into the liquid being mixed in order to enhance the efficacy of the mixing process.

It is an object of this invention to provide a magnetically-coupled liquid mixer in which the position of the driven portion on the stub shaft maintains its position under a wide range of driven speeds.

Another object of this invention is to provide a magnetically-coupled liquid mixer in which a higher degree of magnetic coupling is achieved.

These and other objects of the invention will be apparent from the following descriptions and from the drawings.

### SUMMARY Of THE INVENTION

The instant invention overcomes the above-noted problems and shortcomings and satisfies the objects of the invention. The invention is an improved magnetically-coupled mixer for liquids. Of particular note is that the instant invention provides a mixer which increases the amount of shear introduced into the liquids being mixed such that liquid mixing of a variety of types of liquids, including but not limited to liquid-into-liquid, powder-into-liquid, viscous liquid-into-liquid (e.g., oil into alcohol), can be achieved quickly and thoroughly.

The mixer of the invention is a magnetically-coupled liquid mixer of the type having a drive mount secured to and extending into a mixing vessel, a vessel-external first magnet array adjacent to the drive mount, a stub shaft extending from the drive mount into the vessel and having a first thrust bearing surface, and a driven portion rotatably-mounted on the stub shaft and having a plurality of radially-extending mixing blades, a second thrust bearing surface, and a second magnet array. The inventive improvement to such mixer is such that each blade of a subset of the mixing blades of the mixer includes an opening through which liquid flows, thereby introducing increased fluid shear introduced into the liquid. Such type of mixer may include the positioning of the first and second arrays with respect to one another being such that the first and second thrust hearing surfaces are spaced apart at least in the absence of above-threshold fluid dynamic thrust forces on the driven portion.

In certain embodiments, the mixer has no opening in every other blade.

In certain preferred embodiments of the inventive mixer, each opening has a major dimension and a minor dimension, and the minor dimension is substantially equal to or greater than the thickness of the blade having the opening. In preferred embodiments of such mixers, the minor dimension of each opening is front about 1.5 to 5 times the thickness of the blade having the opening.

In some embodiments of the inventive mixer, at least a portion of the subset of blades includes more than one opening.

In some highly preferred embodiments of the mixer, the driven portion includes four or more four mixing blades. In particular, in some of these embodiments, the driven portion includes eight mixing blades.

Some embodiments of the inventive mixer include mixing blades which are curved.

In highly preferred embodiments of the mixer, the space between the first and second thrust bearing surfaces is between 0.001 and 0.250 inches.

In some embodiments, the second magnet array is secured in the driven portion with an interference fit.

In highly preferred embodiments of the inventive magnetically-coupled mixer, the magnets in the first magnet array have arcuate outer circumferential surfaces and the magnets of the second magnet array have arcuate inner circumferential surfaces, thereby increasing the magnetic coupling between the arrays. In some such highly preferred embodiments, the magnets in the second magnet array further include arcuate outer circumferential surfaces.

The term “liquid” as used herein includes all types of fluids which are to be mixed in various ways including but not limited to agitating, stirring, blending, suspending, homogenizing, shearing, dispersing, and aerating. Also, the term “liquid” as used herein includes fluids containing solid particles.

The term “minor dimension” as used herein refers to the smaller of the two dimensions which generally define the cross-section of a shear-facilitating opening in a blade of the inventive mixer.

The term “major dimension” as used herein refers to the larger of the two dimensions which generally define the cross-section of a shear-facilitating opening in a blade of the inventive mixer.

### BRIEF DESCRIPTION OF THE DRAWINGS

FIG. 1 is a partial schematic cross-sectional drawing of one embodiment of the inventive mixer, shown as a side view.

FIG. 1A is an enlargement of a portion of FIG. 1 as indicated on FIG. 1, with the first and second thrust bearing surfaces in spaced-apart positions.

FIG. 1B is an enlargement of a portion of FIG. 1 as indicated on FIG. 1, but differs from the indicated portion in FIG. 1 in that the first and second thrust bearing surfaces are in contact with one another.

FIG. 2A is a wireframe perspective view of the driven portion of the embodiment of FIG. 1.

FIG. 2B is a top schematic drawing of the driven portion of FIG. 2A.

FIG. 2C is a bottom schematic drawing of the driven portion of FIG. 2A.

FIG. 2D is a side schematic view of the driven portion of FIG. 2A.

FIG. 3A is a wireframe perspective view of the driven portion of an alternative embodiment of the inventive mixer, with every other blade having no opening.

FIG. 3B is a wireframe perspective view of the driven portion of an alternative embodiment of the inventive mixer, with every other blade having no opening and blades with openings having two parallel openings in each such blade.

FIG. 3C is a wireframe perspective view of the driven portion of an alternative embodiment of the inventive mixer, with every other blade having no opening and blades with openings having two in-line openings in each such blade.

FIG. 4A is a shaded perspective view of the driven portion of the embodiment of FIG. 1.

FIG. 4B is a shaded perspective view of drive mount of the embodiment of FIG. 1.

FIG. 5 is a top-view schematic cross-sectional drawing (section A-A as indicated in FIG. 1) illustrating the first magnet array adjacent to the drive mount and the second magnet array in the driven portion of the embodiment of FIG. 1.

FIG. 6 is a shaded perspective view of a portion of a blade having an opening, in the embodiment of FIG. 1.

FIG. 7 is a reference-view showing the enlarged blade portion of FIG.

7A.

FIG. 7A is an enlarged wireframe cross-sectional perspective view of a portion of a blade having an opening in the embodiment of FIG. 1.

FIG. 8 is a reference view showing the enlarged blade portion of FIG. 8A.

FIG. 8A is an enlarged wireframe cross-sectional perspective view of a portion of a blade having an opening in an alternative embodiment, such blade opening having a larger minor dimension than that of the blade in FIG. 7A.

### DETAILED DESCRIPTION OF PREFERRED EMBODIMENTS

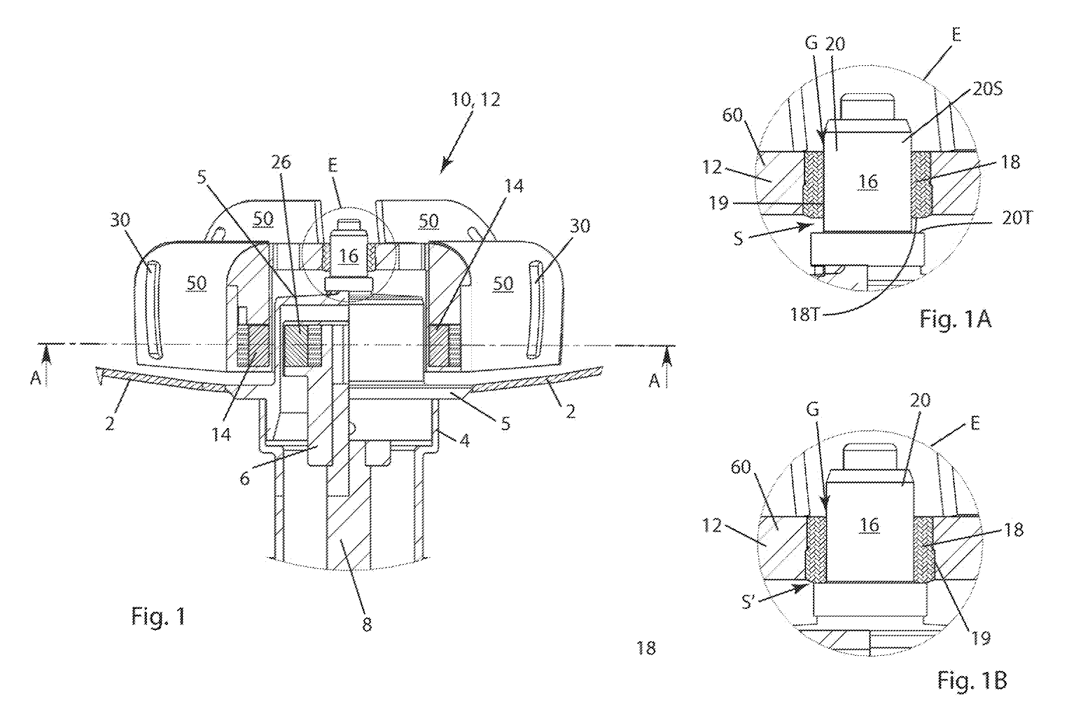

FIG. 1 shows one embodiment of a magnetically-coupled liquid mixer 10. In the figures, magnetically-coupled liquid mixer 10 and its various elements are largely shown in highly schematic fashion. In FIG. 1, the rotary power source for driving mixer 10 through a drive shaft 8 has been left out of the figure to simplify the description of the present invention. The rotary power source can vary significantly. For example, it may be an electric motor, a pneumatic motor, a hydraulic motor, or any other appropriate source of rotary power.

Referring again to FIG. 1, mixer 10 is mounted to a mixing vessel 2 through a drive mount 4, a portion of which extends into vessel 2. For example, drive mount 4 may be welded in an opening of vessel 2, as illustrated in FIG. 1, using a weld plate 5. The rotary power source (not shown) drives mixer 10 through drive shaft 8 which is fixed to a drive hub 6. Drive hub 6 includes a first magnet array 26 comprising a plurality of magnets, such magnets also being indicated by reference number 26 in the figures.

The rotary power from the rotary power source is magnetically-coupled to a second magnet array 14 in a driven portion 12 which also includes mixing blades 50, (Reference number 14 is also the reference number used for the individual magnets in second magnet array 14.) In the embodiment of FIG. 1, each mixing blade 50 has a shear-facilitating opening 30 which increases the amount of shear introduced into the liquid being mixed.

A stub shaft 16 is mounted on drive mount 4. A stub shaft bearing 20 is affixed to stub shaft 16 to provide a suitable load-bearing surface 20S and a first thrust bearing surface 20T (see FIGS. 1A and 1B) for the rotary motion of driven portion 12. (Hereinafter, driven portion 12 will also be referred to as an impeller hub, or simply as hub 12, appropriate for the particular embodiment described herein.)

A hub bearing 18 is mounted in hub 12. Bearings 18 and 20 preferably are made of a carbide compound such as tungsten carbide or silicon carbide which have excellent wear and chemical properties suitable for most applications of mixer 10. Other bearing materials can also be used when needed for other applications. Bearing 18 can be secured to hub 12 using an interference fit 19 assisted in assembly by thermally expanding hub 12 and bearing 18 to permit the two parts to be aligned properly prior to cooling. This interference fit 19 is indicated in FIGS. 1A and 1B as the interface between bearing 18 and hub 12. The use and properties of interference fits are well known to those skilled in the art of mechanical design. The bottom surface of bearing 18 comprises a second thrust bearing surface 18T.

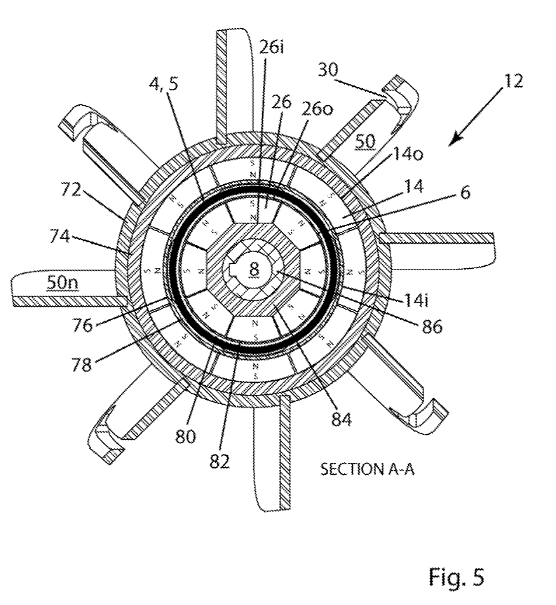

Again referring to FIG. 1, drive hub 6 is positioned in mixer 10 adjacent to drive mount 4 such that the magnetic forces between first magnet array 26 in drive mount 4 and second magnet array 14 in hub 12 position hub 12 on stub shaft 16 with a space S (see FIG. 1A) between first thrust bearing surface 18T and second thrust bearing surface 20T. FIG. 5, showing section A-A as indicated in FIG. 1, schematically illustrates the positioning as viewed from the top of mixer 10, and FIG. 1 schematically illustrates the position of such magnets as viewed from the side. First and second magnet arrays 26 and 14 each contain an even number of permanent magnets. Within each array, the same number of individual magnets are arranged evenly spaced circumferentially in circular fashion with their magnetic fields alternatingly aligned N-to-S and S-to-N with the radial direction as illustrated in FIG. 5. Hub 12 then is positioned by the magnetic field forces in the plane of FIG. 5 as shown in FIG. 5 and perpendicular to the plane of FIG. 5 along the axis of stub shaft 16 as shown in FIG. 1.

The individual magnets in first and second magnet arrays 26 and 14 are preferably rare earth magnets. Such magnets provide particularly strong magnetic forces, desirable to drive hub 12 magnetically-coupled to hub 6 under heavy mixing loads and higher accelerations. In a preferred embodiment, magnets 26 are made of neodymium, a high-magnetic-field and cost-effective magnet material, and magnets 14 are made of samarium-cobalt. Samarium-cobalt does not have quite as strong a magnetic field as neodymium but has a higher Curie point so that it is more appropriate for use in higher temperature environments. Mixer 10 is sometimes used to mix liquids at higher temperatures; thus, using such magnets in hub 12 is advantageous. Suitable rare earth magnets may be obtained from Arnold Magnetic Technologies, 770 Linder Avenue, Rochester, N.Y. 14625.

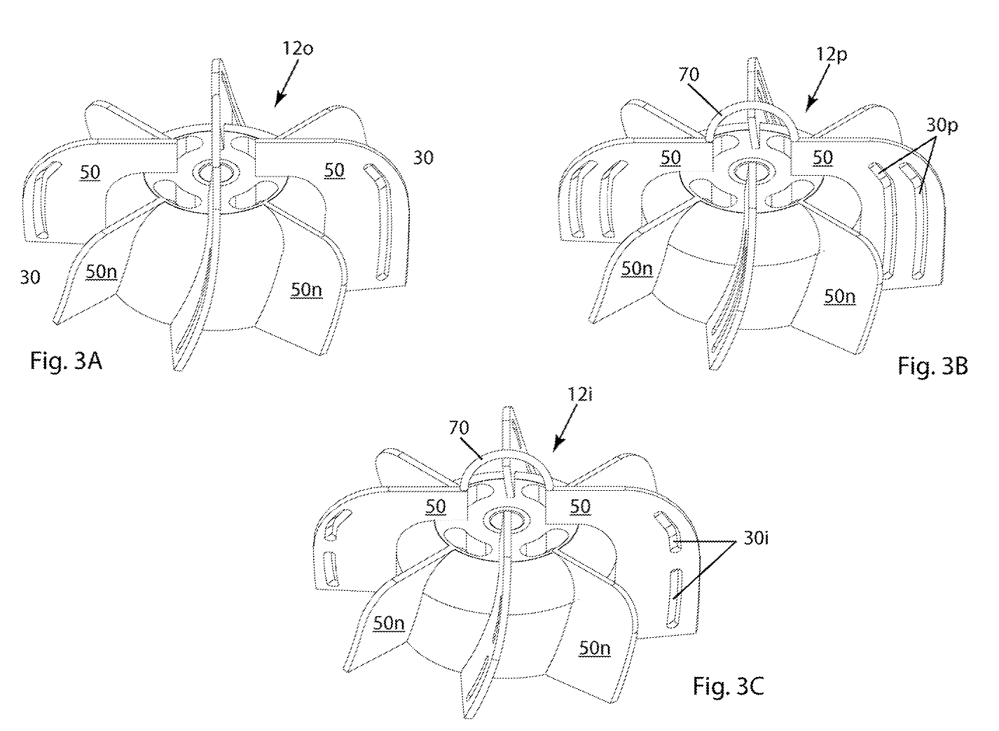

FIGS. 1A and 1B are enlargements of the indicated region E in FIG. 1 illustrating the relative positioning of bearings 18 and 20. When mixer 10 is not in operation (or lightly loaded), hub 12 is positioned such that space S exists between surfaces 18T and 20T as shown in FIG. 3A. Space S is preferably between 0.001 and 0.230 inches, such dimension depending on the particular liquid mixing application of mixer 10. When hub 12 is driven in rotary fashion in a liquid, fluid dynamic forces are placed on hub 12 by the fluid. Some of those forces are thrust forces in the direction of the axis of stub shaft 16, pushing hub 12 further down stub shaft 16. The level of such thrust forces depends on a number of variables such as the viscosity of the liquid being mixed, the rotational speed and acceleration of hub 12, and the level of turbulence in the liquid. The magnetic field forces between first and second magnet arrays 26 and 14 are such that a component of the magnetic force opposes the fluid dynamic thrust forces. A threshold fluid dynamic thrust force is defined as that which overcomes the magnetic forces just enough to drive hub 12 down to completely close space S as illustrated in FIG. 1B in which such closed space is represented by the symbol S′. (Note that the enlarged figure of FIG. 1B is also indicated by reference number E, as in FIG. 1A, even though it is illustrating a different position for hub 2 than that of FIG. 1.)

The function of space S is to provide operation of mixer 10 under below-threshold forces such that (1) no wear particles are produced due to contact between first and second thrust bearing surfaces 18T and 20T, and (2) liquid can flow through space S to avoid stagnation of any liquid in the region around space S and to enable cleaning of such region when vessel 2 and mixer 10 undergo cleaning. In particular, wear between bearing surfaces is exacerbated by mixer 10 operating without the presence of liquid. This can occur when the level of the liquid product in vessel 2 falls below the level of the thrust bearing surfaces or when vessel 2 is cleaned. Since the products mixed in vessel 2 are often highly valuable, it is imperative that vessel 2 be able to be emptied completely in order to utilize all of such product. This emptying process therefore often causes mixer 10 to be operated in such a “dry” condition. In the same way, during at least a portion of the vessel cleaning process, mixer 10 operates in a “dry” condition. Space S prevents wear particles from being generated in such a “dry” condition.

Further, the function of space S is such that when the fluid dynamic thrust forces are above the threshold, space S is completely closed as represented by S′ in FIG. 1B, thereby providing stable thrust-bearing support to hub 12 under operating conditions during which it is most desirable to have such stability.

Again referring to FIG. 1A, hub bearing 18 and sleeve bearing 20 have bearing surfaces 18S and 20S, respectively. Bearing surfaces 18S and 20S provide support for hub 12 against the non-thrust loads on hub 12. Bearings 18 and 20 are preferable sized such that a gap G exists between bearing surfaces 18S and 20S. Gap G is preferably between 0.0005 and 0.003 inches, too small to be illustrated in the enlarged schematic FIGS. 1A and 1B. The function of gap G is to minimize the wobbling motion of hub 12 while allowing liquid to flow through gap G in order to prevent stagnation of liquid in the region of gap G and to enable cleaning in the region of gap G.

The combined functions of space S and gap G enable mixer 10 to provide stable ultraclean operation in liquids which require ultraclean mixing. Both wear particles and inadequate cleaning are sources of contamination which it is desirable to eliminate from the mixing of products such as pharmaceuticals and certain food products.

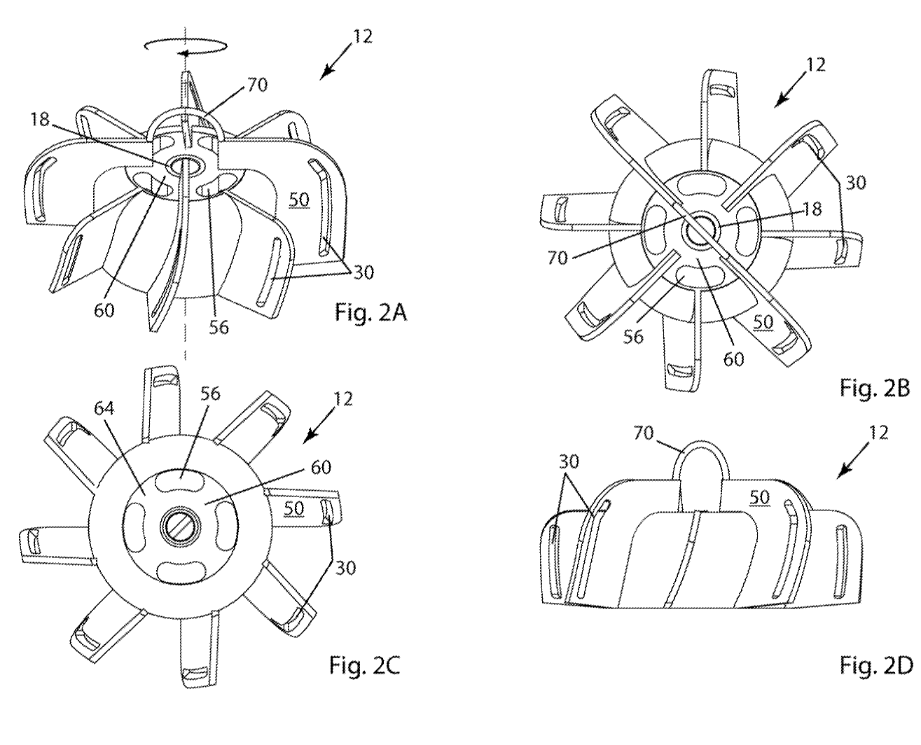

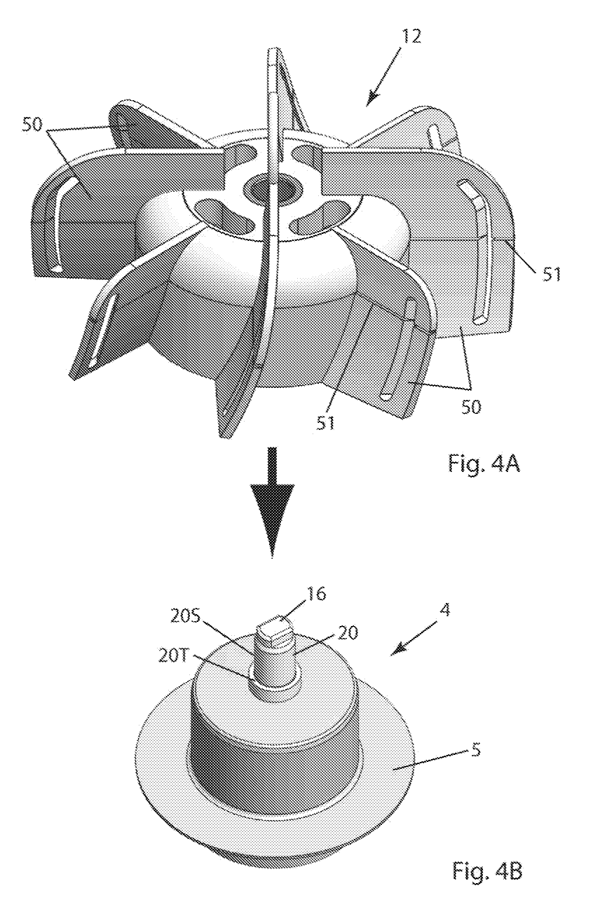

FIGS. 2A-2D illustrate driven portion 12 (hub 12) using several different views, in wireframe perspective and top, bottom and side elevations, respectively. Referring to FIGS. 2A-2D, center portion 56 of hub 12 is open to allow liquid to reach gap G and space S easily. Center portion 56 is an annular portion with openings between a central cylinder 60 into which bearing 18 is secured and an outer cylinder 58 in which second magnet array 14 is mounted (also see FIG. 5). Center cylinder 60 and outer cylinder 58 are held in such spaced-apart fashion by openings with four web spokes 64 as shown in the bottom view of FIG. 4C.

Each blade 50 of the embodiment in FIGS. 2A-2D contains one shear-facilitating opening 30. Hub 12 also includes a loop 70 to assist in the assembly and removal of hub 12 from vessel 2. The perspective view of FIG. 2A, particularly blade 50 in the front of hub 12, illustrates the curved shape of blades 50 to create a desired mixing flow in vessel 2 and the desired axial forces on hub 12 during rotation. Hub 12 is driven in a clockwise direction as viewed from the top of hub 12.

FIGS. 3A-3C illustrate three alternative embodiments of impeller hub 12 in wireframe perspective views. FIG. 3A shows hub 12o in which every other blade has no opening 30. Thus, the blades of hub 12o alternate between a blade 50n with no opening and a blade 50 with an opening 30.

FIGS. 3B and 3C show variations of hub 12o. FIG. 3B illustrates hub 12p in which blades 50 each include two parallel openings 30p, and FIG. 3C depicts hub 12i in which blades 50 each include two in-line openings 30i. The number and configuration of openings 30 (i.e., 30, 30p, 30i) in blades 50 and whether every other blade has an opening represent, some of the ways in which the amount of shear introduced into the liquid being mixed can be varied.

The shaded perspective views of FIGS. 4A and 4B provide further illustration of the FIG. 1 embodiment of mixer 10 by showing how hub 12 is lowered into place on drive mount 4. FIG. 4A also further illustrates the curved shape of blades 50. In the shaded perspective view of FIG. 4A, the drawing of blades 50 each include a computer drawing anomaly which represents a weld line 51. In the physical embodiment, such anomalous discontinuities are not present.

Referring again to FIG. 5, which is section A-A as indicated in FIG. 1 viewed from the top, illustrates the assembly of hub 12, drive hub 6 and portions of drive mount 4 in cross-section. The structure of these elements in the embodiment shown is largely concentric in nature. In the cross-section of FIG. 5, the outer concentric layer of hub 12 is an outer portion 72 of an impeller base, which can be made of stainless steel or other suitable material, depending on the application of mixer 10. Inside of impeller base outer portion 72 is a second magnet array ring 74 which may be made of high carbon steel or other suitable low-reluctance material.

Immediately inside of ring 74, arcuate magnets 14 of the second magnet array (also 14) are assembled in an annular arrangement with the magnet poles as shown and as previously described. Magnets 14 have both arcuate outer circumferential surfaces 14o and inner circumferential surfaces 14i in order to increase the volume of magnet material available and increasing the magnetic coupling between second magnet array 14 and first magnet array 26. In this embodiment, magnets 14 are samarium-cobalt rare earth magnets but other suitable magnet materials may be used.

Ring 74 and magnets 14 are retained by an inner portion 76 of the impeller base such that impeller base inner portion 76 and impeller base outer portion 72 form a annular space to hold ring 74 and second magnet array 14. Magnets 54 and ring 76 are further held in place with a high-temperature epoxy (not shown). The high-temperature epoxy may be any suitable epoxy such as Duralco NM25 magnet bonding adhesive made by Cotronics Corporation, 3379 Shore Parkway, Brooklyn, N.Y., 11235.

In FIG. 5, three concentric layers are shown immediately inside of impeller base inner portion 76: a first gap 78, weld plate 5, and a second gap 80. In cross-section, the concentric space indicated as weld plate 5, together with first gap 78 and second gap 80, all form an annular clearance space between impeller hub 12 and drive hub 6 during operation.

The outer layer of drive hub 6 is a drive mount cap 82. Cap 82 can be made of stainless steel or other suitable material, depending on the application of mixer 10. Inside of cap 82 are magnets 26 of first magnet array (also 26). In this embodiment, magnets 26 have outer circumferential surfaces 26o and flat inner circumferential surfaces 26i in order to increase the magnetic coupling between second magnet array 14 and first magnet array 26. In this embodiment, magnets 26 are neodymium rare earth magnets but other suitable magnet materials may be used.

Flat inner circumferential surfaces 26i of magnets 26 are arranged around a first magnet array ring 84 which may be made of high carbon steel or other suitable low-reluctance material. Inside ring 84 is drive sleeve 86 info which drive shaft 8 is placed in order to drive impeller hub 12. Sleeve 86 may be made of aluminum or other suitable material, again depending on the particular application of mixer 10.

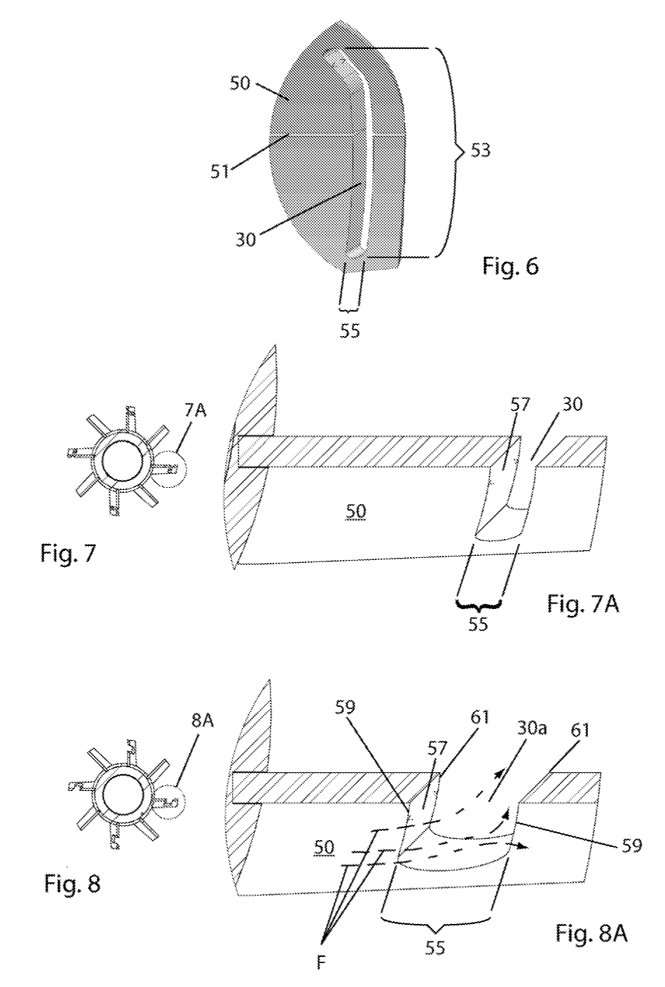

FIG. 6 is a shaded perspective view of a portion of blade 50 including opening 30. As with the shaded perspective view of FIG. 4A, the drawing of blade 50 includes a computer drawing anomaly which represents weld line 51. In the physical embodiment, such an anomalous discontinuity is not present.

FIG. 6 illustrates relative dimensions in one embodiment of blade 50. Opening 30 has a major dimension 53 and a minor dimension 55 as shown. Blade 50 as shown in FIG. 6 also has thickness 57, and minor dimension 53 in this embodiment is substantially equal to thickness 57.

FIG. 7 is a reference view showing the enlarged blade portion of FIG. 7A; the portion of FIG. 7 which has been enlarged is labeled 7A. FIG. 7A is an enlarged wireframe cross-sectional perspective view of a portion of blade 50 including opening 30. Similar to the embodiment of FIG. 6, minor dimension 53 is substantially equal to thickness 57.

FIG. 8 is a reference view showing the enlarged blade portion of FIG. 8A; the portion of FIG. 8 which has been enlarged is labeled 8A. FIG. 8A is an enlarged wireframe cross-sectional perspective view of a portion of blade 50 having an opening 30a in an alternative embodiment, such opening 30a having minor dimension 53 approximately two times thickness 57. Such relative dimensions, again depending on the particular application of mixer 10, have an effect on the shear-facilitating performance of openings 30 in blades 50.

Referring again to FIG. 8A, representative flow lines F are shown (dotted lines with directional arrowheads), not as precise representations of flow but only as general illustrations. As an example, opening 30a includes two sharp leading edges 59 and two sharp trailing edges 61, all of which serve as locations at which shear can be introduced into the liquid flow through and around opening 30a. Trailing edge 61 shown on the right in FIG. 8A is only represented by a single corner in the cross-sectional view. As liquid flows over both sharp leading and trailing edges 59 and 61, turbulent flow and flow separation can occur (depending on flow conditions affected by rotational blade speed and liquid properties), thereby introducing shear into the flow and resulting in more rapid and complete mixing of the liquid being processed.

While the principles of this invention have been described in connection with specific embodiments, it should be understood clearly that these descriptions are made only by way of example and are not intended to limit the scope of the invention.

1. In a magnetically-coupled liquid mixer of the type having: (a) a drive mount secured to and extending into a mixing vessel; (b) a vessel-external first magnet array adjacent to the drive mount; (c) a stub shall extending from the drive mount into the vessel and having a first thrust bearing surface; and (d) a driven portion rotatably-mounted on the stub shaft and having a plurality of radially-extending mixing blades, a second thrust bearing surface, and a second magnet array, the positions of the first and second arrays with respect to one another being such that the first and second thrust bearing surfaces are spaced apart at least in the absence of above-threshold fluid dynamic thrust forces on the driven portion, the improvement wherein each blade of a subset of the mixing blades includes an opening through which liquid flows, whereby the fluid shear introduced into the liquid is increased.

2. The mixer of claim 1 wherein every other blade has no opening.

3. The mixer of claim 1 wherein each opening has a major dimension and a minor dimension and the minor dimension is substantially equal to or greater than the thickness of the blade having the opening.

4. The mixer of claim 3 wherein the minor dimension of each opening is from about 1.5 to 5 times the thickness of the blade having the opening.

5. The mixer of claim 1 wherein at least a portion of the subset of blades includes more than one opening.

6. The mixer of claim 1 wherein the driven portion includes four or more mixing blades.

7. The mixer of claim 6 wherein the driven portion includes eight mixing blades.

8. The mixer of claim 1 wherein the mixing blades are curved.

9. The mixer of claim 1 wherein the space between the first and second thrust bearing surfaces is between 0.001 and 0.250 inches.

10. The mixer of claim 1 wherein the second magnet array is secured in the driven portion with an interference fit.

11. The mixer of claim 1 wherein the magnets in the first magnet array have arcuate outer circumferential surfaces and the magnets of the second magnet array have arcuate inner circumferential surfaces, whereby the magnetic coupling between the arrays is increased.

12. The mixer of claim 11 wherein the magnets in the second magnet array further include arcuate outer circumferential surfaces.

13. In a magnetically-coupled liquid mixer of the type having: (a) a drive mount secured to and extending into a mixing vessel; (b) a vessel-external first magnet array adjacent to the drive mount; (c) a stub shaft extending from the drive mount into the vessel and having a first thrust bearing surface; and d) a driven portion rotatably-mounted on the stub shaft and having a plurality of radially-extending mixing blades, a second thrust bearing surface, and a second magnet array, the improvement wherein each blade of at least a subset of the mixing blades includes an opening through which liquid flows, whereby the fluid shear introduced into the liquid is increased.

14. The mixer of claim 13 wherein every other blade has no opening.

15. The mixer of claim 13 wherein each opening has a major dimension and a minor dimension and the minor dimension is substantially equal to or greater than the thickness of the blade having the opening.

16. The mixer of claim 15 wherein the minor dimension of each opening is from about 1.5 to 5 times the thickness of the blade having the opening.

17. The mixer of claim 13 wherein at least a portion of the subset of blades includes snore than one opening.

18. The mixer of claim 13 wherein the driven portion includes four or more mixing blades.

19. The mixer of claim 18 wherein the driven portion includes eight mixing blades.

20. The mixer of claim 13 wherein the magnets in the first magnet array have arcuate outer circumferential surfaces and the magnets of the second magnet array have arcuate inner circumferential surfaces.

21. The mixer of claim 20 wherein the magnets in the second magnet array further include arcuate outer circumferential surfaces.
